(19) United States
(12) Patent Application Publication
(10) Pub. No.: US 2018/0285559 A1
(43) Pub. Date: Oct. 4, 2018

(54) STACK PIVOT DETECTION SYSTEMS AND METHODS

(71) Applicants: Rodrigo Branco, Hillsboro, OR (US); Xiaoning Li, Portland, OR (US); David M. Durham, Beaverton, OR (US); Hongliang Gao, Hillsboro, OR (US); Stephen A. Fischer, Gold River, CA (US); Baiju V. Patel, Portland, OR (US)

(72) Inventors: Rodrigo Branco, Hillsboro, OR (US); Xiaoning Li, Portland, OR (US); David M. Durham, Beaverton, OR (US); Hongliang Gao, Hillsboro, OR (US); Stephen A. Fischer, Gold River, CA (US); Baiju V. Patel, Portland, OR (US)

(21) Appl. No.: 15/472,181

(22) Filed: Mar. 28, 2017

(51) Int. Cl. G06F 21/52; G06F 21/55; G06F 15/78

(52) U.S. Cl. CPC G06F 21/52; G06F 2221/034; G06F 15/7839; G06F 21/552

(57) ABSTRACT

The present disclosure is directed to systems and methods for detecting stack-pivot attacks in a processor-based device. Processor circuitry executes one or more applications via sequential execution of instructions on a stack. Stack pivot attacks occur when an attacker takes control of the stack and uses the stack to execute a series of code sections referred to as “gadgets.” A stack-pivot attack detector establishes an allowable processor stack offset change value associated with an application and monitors a processor stack offset change value responsive to an occurrence of a processor stack exchange instruction. A stack-pivot attack is detected when the processor offset change value exceeds the allowable processor stack offset change value. Upon detecting a stack-pivot attack, the stack-pivot detection circuitry causes the selective termination of the application.

### TECHNICAL FIELD

The present disclosure relates to technologies for detecting stack-pivot attacks on a processor-based device.

### BACKGROUND

Return oriented programming (ROP) is a technique used to exploit software vulnerabilities. An attacker using ROP forces an out-of-sequence or out-of-order execution of the instructions included in the code currently running in a processor, thereby causing the execution of unexpected, or arbitrary, computations. A gadget is a code fragment that an attacker may re-use to perform a fraction of the desired computation. Such gadgets usually terminate in a “ret” instruction which returns control to the processor stack and causes the execution of the instruction addressed by the top of the processor stack. Gadgets perform a given computation, but many times will include instructions that do not change or alter the intended result for the gadget. Return oriented programming includes grouping different gadgets to perform a malicious computation selected by the attacker. Using ROP, the attacker uses return addresses on the stack and since each gadget terminates with the ret instruction, the processor automatically executes the instruction at the top of the stack. Usually, the instruction causes the execution of the next gadget in the sequence selected by the attacker.

Some system vulnerabilities provide the attacker with immediate access to the top of the stack (e.g., stack based buffer overflows), providing relatively straightforward control of the gadgets. In more complex scenarios, such as heap-based buffer overflows, type confusions, and similar, the attacker does not initially have the same control over the stack. In such instances, the attacker typically pivots the stack to another memory area (usually the heap), abusing any xchg esp, register instruction to point the stack to a memory area under the control of the attacker and commence execution of the ROP gadgets.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is a schematic diagram of an illustrative system that includes processor circuitry, memory, and one or more storage devices, in accordance with at least one embodiment described herein;

FIG. 2A is a schematic diagram of an illustrative data structure that includes four illustrative process control structures, each configured to detect stack-pivot attacks in a respective one of four applications, the data structure includes two pointers, a first pointer (“list_head”) and a second pointer (“list_tail”) in accordance with at least one embodiment described herein;

FIG. 2B is a schematic diagram of an illustrative data structure that includes four illustrative process control structures and a new process control structure logically associated with an application not previously represented in data structure, in accordance with at least one embodiment described herein;

FIG. 3 is a block diagram that depicts the components forming an illustrative processor-based device capable of implementing stack-pivot detection circuitry to detect stack-pivot attacks, in accordance with at least one embodiment described herein;

FIG. 4 is a high-level logic flow diagram of an illustrative stack-pivot detection method, in accordance with at least one embodiment described herein; and

FIG. 5 is a high-level logic flow diagram of an illustrative stack-pivot detection method, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

The systems, methods, and apparatuses disclosed herein create a combined stack pointer watching service that may be invoked in different ways without adversely impacting overall system performance. The watching service may be called by event handler, intercepted (hooked) functions, binary instrumentation, or even the system scheduler, or a combination of events selected based on system security and performance requirements. The systems and methods disclosed herein have constant execution time, advantageously providing a predictable and consistent impact on system performance and application execution. Different timer watchers may be used by the system, calling this watching service in variable-frequency times. The relatively light weight of the systems and methods disclosed herein benefits Internet of Things (IoT) and real-time operating systems (OSes) due to the known, predictable, and consistent latency.

Typically, in order for an attacker to create the pivot, they will use an existing code sequence that includes an xchg esp, register followed by a ret. Note that the code between the xchg esp and the ret is irrelevant, the only requirement is that the code does not break the application. The systems and methods described herein advantageously detect stack pivots with minimal impact on system performance. Thus, the systems and methods described herein may be implemented in the system scheduler of the operating system (and in other scenarios as instrumented functions or random time events). Although xchg esp, register, and ret are used as an illustrative example for clarity and ease of discussion, one of ordinary skill in the art will readily appreciate any similar commands or instructions capable of changing the stack location or pointer may be used instead of xchg esp, register, and ret to effect a similar stack pivot attack. Such embodiments, and any future developed commands or instructions should therefore be considered to fall within the scope of this disclosure.

The systems and methods disclosed herein perform a single check: does the previously known 32-bit stack pointer (ESP) or 64-bit stack pointer (RSP) (hereinafter, “ESP/RSP”) for this process change by more than “X” bytes (where “X” is the stack size for the respective process or a value decided by the monitoring software)? If the stack pointer does change more than “X” bytes, stack pivot is detected and corrective action is initiated by the system. Such corrective actions may include, but are not limited to, not scheduling the process, terminating the process, logging the process activity, or combinations thereof. Usually, the system will mark the process for termination if run inside a system scheduler since the system has been exploited and no reliable recovery method exists. On the other hand, if the stack pointer does not change by more than “X” bytes, the previously saved ESP/RSP value is updated with the current value and process execution continues (and “X” is updated).

In embodiments, the systems and methods disclosed herein may be implemented as a module or similar element and therefore does not depend on changes in the operating system. In embodiments, the systems and methods disclosed herein should, upon loading: allocate a fixed-size list that includes “N” elements, where “N” represents an acceptable size for the acceptable latency. The list of pointer is checked in its entirety, thus, the bigger the list, the greater the latency. Such pre-allocation however removes the latency associated with allocating/deallocating and dealing with memory faults in an interrupt context. Three pointers are maintained in the list: “list_head,” “list_current,” and “list_tail.” The “list_head” and “list_tail” pointers move as in a circular list to implement last recently used (LRU) replacement. The list includes three pieces of information on the process: a process identifier; a process structure pointer (pointing to the internal operating system structure that manages the process); and the saved ESP/RSP value associated with the process. In embodiments, the system scheduler, when called: checks if the currently scheduled program is on the list (i.e., check if the process pointer was included in the list and confirm with the process identifier). If the pointer is included in the list, determine whether the change in the ESP/RSP value for the process structure has exceeded “X” bytes from the previously saved ESP/RSP value (where “X” is the maximum stack size associated with the process). If the change in ESP/RSP value exceeds “X” bytes, a stack pivot attempt has been detected, do not schedule the process and mark the process for elimination since the process has been exploited and recovery is not possible. If the change in ESP/RSP value does not exceed “X” bytes, update the ESP/RSP value with the current ESP/RSP value, “X” with the new available stack size and execute the process. If the currently scheduled program is not included in the list, add the process “list_head” (this is a pointer replacement and two assignments), point “list_tail” to the “list_head”, and point “list_head” to the next element in the list.

A system to detect processor stack-pivot attacks is provided. The system, may include: processor circuitry; a memory communicably coupled to the processor circuitry; and a storage device that includes instructions that, when executed by the processor circuitry causes the processor circuitry to: determine an allowable processor stack offset change value for an application executed by the processor circuitry; detect an occurrence of a processor stack exchange instruction and a processor stack update in the application executed by the processor circuitry; determine a processor stack offset change value for the application responsive to detection of the processor stack exchange instruction and the resultant processor stack update; compare the determined processor stack offset change value to the determined allowable processor stack offset change value for the application; and cause a selective termination of the application responsive to a detected stack-pivot indicated by the determined processor stack offset change value exceeding the determined allowable processor stack offset change value.

A method to detect processor stack pivoting attacks is provided. The method may include: determining, by processor circuitry, an allowable processor stack offset change value for an application executed by the processor circuitry; detecting, by the processor circuitry, an occurrence of a processor stack exchange instruction and a processor stack update in the application executed by the processor circuitry; determining, by the processor circuitry, a processor stack offset change value for the application responsive to detection of the processor stack exchange instruction and the processor stack update; comparing, by the processor circuitry, the determined processor stack offset change value to the determined allowable processor stack offset change value; and causing, by the processor circuitry, selective termination of the application responsive to a detected stack-pivot indicated by the determined processor stack offset change value exceeding the determined allowable processor stack offset change value.

A system to detect processor stack pivoting attacks is provided. The system may include a means for determining an allowable processor stack offset change value for an application executed by the processor circuitry; a means for detecting, by the processor circuitry, an occurrence of a processor stack exchange instruction and a processor stack update in the application executed by the processor circuitry; a means for determining a processor stack offset change value for the application responsive to detection of the processor stack exchange instruction and the processor stack update; a means for comparing the determined processor stack offset change value to the determined allowable processor stack offset change value; and a means for causing selective termination of the application responsive to a detected stack-pivot indicated by the determined processor stack offset change value exceeding the determined allowable processor stack offset change value.

A stack-pivot detection apparatus is provided. The stack-detection apparatus may include stack-pivot detection circuitry to: determine an allowable processor stack offset change value for an application executed by processor circuitry; detect an occurrence of a processor stack exchange instruction and a processor stack update in the application executed by the processor circuitry; determine a processor stack offset change value for the application responsive to detection of the processor stack exchange instruction and the resultant processor stack update; compare the determined processor stack offset change value to the determined allowable processor stack offset change value for the application; and cause a selective termination of the application responsive to a detected stack-pivot indicated by the determined processor stack offset change value exceeding the determined allowable processor stack offset change value.

A non-transitory computer readable medium that includes instructions is provided. The instructions, when executed by processor circuitry, may cause the processor circuitry to: determine an allowable processor stack offset change value for an application executed by the processor circuitry; detect an occurrence of a processor stack exchange instruction and a processor stack update in the application executed by the processor circuitry; determine a processor stack offset change value for the application responsive to detection of the processor stack exchange instruction and the resultant processor stack update; compare the determined processor stack offset change value to the determined allowable processor stack offset change value for the application; and cause a selective termination of the application responsive to a detected stack-pivot indicated by the determined processor stack offset change value exceeding the determined allowable processor stack offset change value.

As used herein the terms “top,” “bottom,” “lowermost,” and “uppermost” when used in relationship to one or more elements are intended to convey a relative rather than absolute physical configuration. Thus, an element described as an “uppermost element” or a “top element” in a device may instead form the “lowermost element” or “bottom element” in the device when the device is inverted. Similarly, an element described as the “lowermost element” or “bottom element” in the device may instead form the “uppermost element” or “top element” in the device when the device is inverted.

As used herein, the term “logically associated” when used in reference to a number of objects, systems, or elements, is intended to convey the existence of a relationship between the objects, systems, or elements such that access to one object, system, or element exposes the remaining objects, systems, or elements having a “logical association” with or to the accessed object, system, or element. An example “logical association” exists between relational databases where access to an element in a first database may provide information and/or data from one or more elements in a number of additional databases, each having an identified relationship to the accessed element. In another example, if “A” is logically associated with “B,” accessing “A” will expose or otherwise draw information and/or data from “B,” and vice-versa.

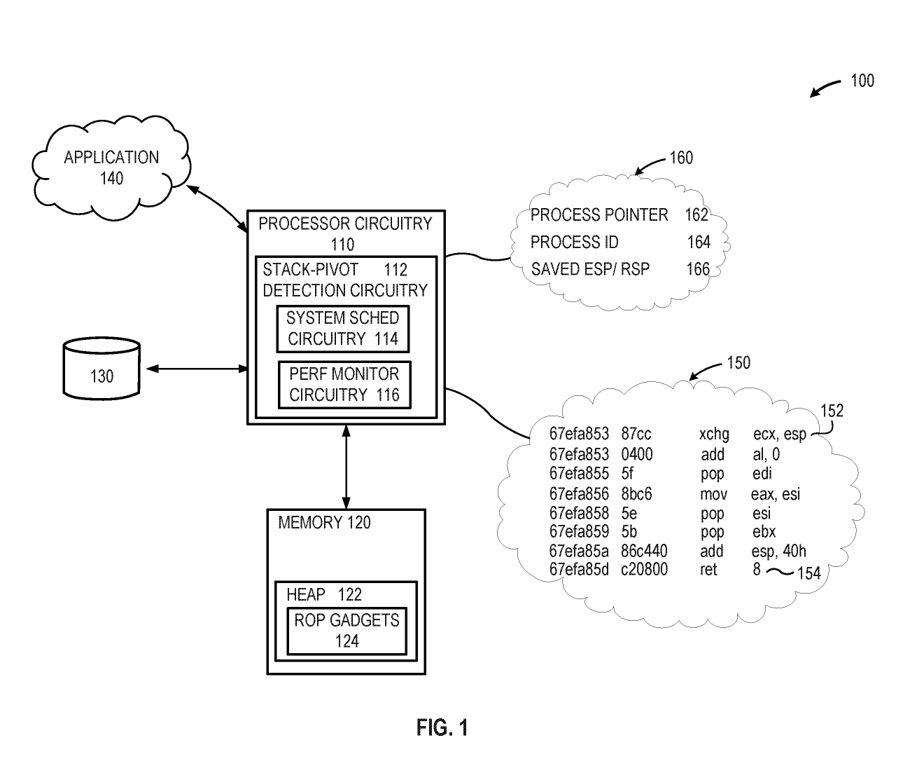

FIG. 1 depicts an example system 100 that includes processor circuitry 110, memory 120, and one or more storage devices 130, in accordance with at least one embodiment described herein. As depicted in FIG. 1, the system 100 may execute one or more applications 140. As depicted in FIG. 1, at least a portion of the processor circuitry 110 may include stack-pivot detection circuitry 112. Upon execution by the processor circuitry 110, each application 140 causes instructions associated with the execution of the application 140 to appear on the stack 150. The stack 150 is a portion of memory assigned to a particular application 140. In embodiments, the stack 150 has a fixed size (e.g., a fixed size in bytes) and as instructions are executed by the processor circuitry 110, the instructions are removed from the stack and the processor circuitry causes the execution of the next, or subsequent, instruction included in the stack 150. Each application 140 also includes one or more memory portions 122, typically referred to as a “heap.” As the application 140 executes, instructions included in the stack 150 may point the stack 150 to a customized buffer or similar portion of memory 120 where malicious code in the form of return oriented programming (ROP) gadgets 124 may be present. Once an attacker is able to pivot the stack 150 to point to the ROP gadgets 124 in memory, the attacker is able to cause the execution of any number (e.g., tens, hundreds, or even thousands) of such ROP gadgets 124, some or all of which may have a malicious effect on the system 100.

As depicted in FIG. 1, an exchange instruction (xchg) 152 appears at the top of the stack 150 and a return instruction (ret) 154 appears lower within the stack 150. Other instructions appear between the exchange instruction 152 and the return instruction 154. As depicted in FIG. 1, the exchange instruction 152 swaps the contents of a 32-bit stack pointer (esp) register with the contents of a second register (ecx). If the second register (ecx) is under the control of an attacker, the attacker effectively controls the top of the stack and may cause the execution of malicious or unintended code by the processor circuitry 110. Once swapped, the stack 150 has been “pivoted” and the stack pointer (esp) will now execute the attacker's instructions inserted in the second register (ecx).

The stack 150 may have any size. In some implementations, the stack size may be based, at least in part on one or more operating parameters of the system 100. In embodiments, the processor circuitry 110 and/or the stack-pivot detection circuitry 112 may determine an allowable processor stack offset change value which is the maximum permissible change in the stack pointer allowed for program 140. In embodiments, the processor circuitry 110 and/or the stack-pivot detection circuitry 112 may select or otherwise determine the allowable processor stack offset change value based on the size of the largest subroutine included in a given application 140. In other embodiments, the processor circuitry 110 and/or the stack-pivot detection circuitry 112 may select or otherwise determine the allowable processor stack offset change value based on the size of the stack 150. Where multiple applications 140A-140n are executed (e.g., in using multi-core processor circuitry 110 or using a multi-threaded processor circuitry 110), the processor circuitry 110 and/or the stack-pivot detection circuitry 112 may select or otherwise determine the same or different allowable processor stack offset change values for each respective one of the applications 140.

The processor circuitry 110 may include any number and/or combination of electric components, semiconductor devices, and/or logic elements capable of executing machine-readable instruction sets. The processor circuitry 110 may include any number and/or combination of single- or multi-core processor controllers, microcontrollers, processors, microprocessors, or similar. The processor circuitry 110 may include one or more: application specific integrated circuits (ASICs), reduced instruction set computers (RISCs), systems-on-a-chip (SoCs), or similar.

In some implementations, at least a portion of the processor circuitry 110 may form, provide, or otherwise include stack-pivot detection circuitry 112. In embodiments, the stack-pivot detection circuitry 112 may perform or otherwise provide some or all of the stack-pivot detection capabilities described herein. In some implementations, at least a portion of the processor circuitry 110 may provide system scheduler circuitry 114. In embodiments, the system scheduler circuitry 114 may perform or otherwise provide some or all of the stack-pivot detection capabilities described herein. In some implementations, at least a portion of the processor circuitry 110 may form, provide, or otherwise include system and/or processor performance monitoring circuitry 116. In embodiments, the system and/or processor performance monitoring circuitry 116 may perform or otherwise provide some or all of the stack-pivot detection capabilities described herein. In some implementations, the processor circuitry 110 may perform or otherwise provide some or all of the stack-pivot detection circuitry 112, system scheduler circuitry 114, and/or the system and/or processor performance monitoring circuitry 116. In embodiments, any combination of some or all of the processor circuitry 110 may perform or otherwise provide some or all of the stack-pivot detection circuitry 112, system scheduler circuitry 114, and/or the system and/or processor performance monitoring circuitry 116 may perform or otherwise provide some or all of the stack-pivot detection capabilities described herein. In implementations, the processor circuitry 110 may selectively provide a watching service called by at least one of: an event handler, an intercepted function binary instrumentation, or the system scheduler, the watching service to detect an occurrence of a processor stack exchange instruction and a processor stack update in one or more applications executed by the processor circuitry.

The memory 120 may include one or more storage media or storage devices capable of storing digital information and/or data. The memory 120 directly (i.e., with no intervening devices and/or components) or indirectly (i.e., through or via one or more intervening devices and/or components) communicably couples to the processor circuitry 110. The memory 120 may have any include any number or combination of magnetic memory, electromagnetic memory, electro-resistive memory, optical memory. In embodiments, at least a portion of the memory 120 may include one or more heaps 122, each of the one or more heaps 122 may be logically associated with an application 140 executed by the processor circuitry 110. In some implementations, all or a portion of the memory 120 may include fixed or removable memory. In some implementations, all or a portion of the memory 120 may be disposed in, on, or about the processor circuitry 110. In some implementations, all or a portion of the one or more applications 140 may be stored in the memory 120 for execution by the processor circuitry 110.

The storage device 130 includes any number and/or combination of non-transitory storage devices capable of storing or otherwise retaining information and/or data. The storage device 130 may be communicably coupled to either or both the processor circuitry 110 and/or the memory 120. The storage device 130 may include any number and/or combination of fixed and/or removable storage devices. Example storage devices 130 include, but are not limited to: magnetic storage devices, electromagnetic storage devices, electro-resistive storage devices, optical storage devices, quantum storage devices, molecular storage devices, biochemical storage devices, or combinations thereof. In at least some implementations, all or a portion of the one or more applications 140 may be stored, disposed, or otherwise retained in, on, or about the storage device 130. In embodiments, the storage device 130 may store or otherwise retain instruction sets that cause the processor circuitry 110 to provide all or a portion of the stack-pivot detection circuitry 112, system scheduler circuitry 114, and/or the performance monitoring circuitry 116.

The application 140 may include any number or combination of programs, logic sets, instruction sets, or similar. Any number of applications 140 may be executed sequentially and/or simultaneously by the processor circuitry 110. For example, in some implementations, the processor circuitry 110 may include multi-threading technology which enables the concurrent execution of a number of applications. In another example, the processor circuitry 110 may include multiple processing cores able to concurrently execute a number of applications 140. The stack-pivot detection circuitry 112 stores or otherwise retains information regarding each application 140A-140n in a respective process control data structure 160A-160n that is logically associated with a particular application 140. Each process control data structure 160 includes a process pointer 162 used to point to locations or registers in a memory, such as an embedded memory in the processor circuitry 110 or system memory 120, a process identifier 164 that uniquely identifies the application 140 with which the process control block 160 is logically associated, and a stack pointer 166 that identifies the memory location or register where containing the next instruction for execution by the processor circuitry 110.

For simplicity and ease of discussion, the following description involves only a single application 140. Those of ordinary skill in the relevant arts will readily appreciate the broad applicability of the principles, systems, and methods described herein across a wide number of applications 140. In operation, the stack-pivot detection circuitry 112 determines an allowable processor stack offset change value for an application 140 executed by the processor circuitry 110. The stack-pivot detection circuitry 112 monitors the processor stack 150 associated with the application to detect an occurrence of a processor stack exchange instruction (xchg) 152 and a processor stack update. Responsive to detecting the occurrence of the processor stack exchange instruction (xchg) 152, the stack-pivot detection circuitry 112 determines a processor stack offset change value for the application. The stack-pivot detection circuitry 112 compares the determined processor stack offset change value with the allowable processor stack offset change value for the application 140. Responsive to a detected stack-pivot indicated by the determined processor stack offset change value exceeding the determined allowable processor stack offset change value, the stack-pivot detection circuitry 112 causes a selective termination of the application 140. Responsive to the determined processor stack offset change value being less than or equal to the determined allowable processor stack offset change value, the stack-pivot detection circuitry 112 causes a selective execution of the application 140.

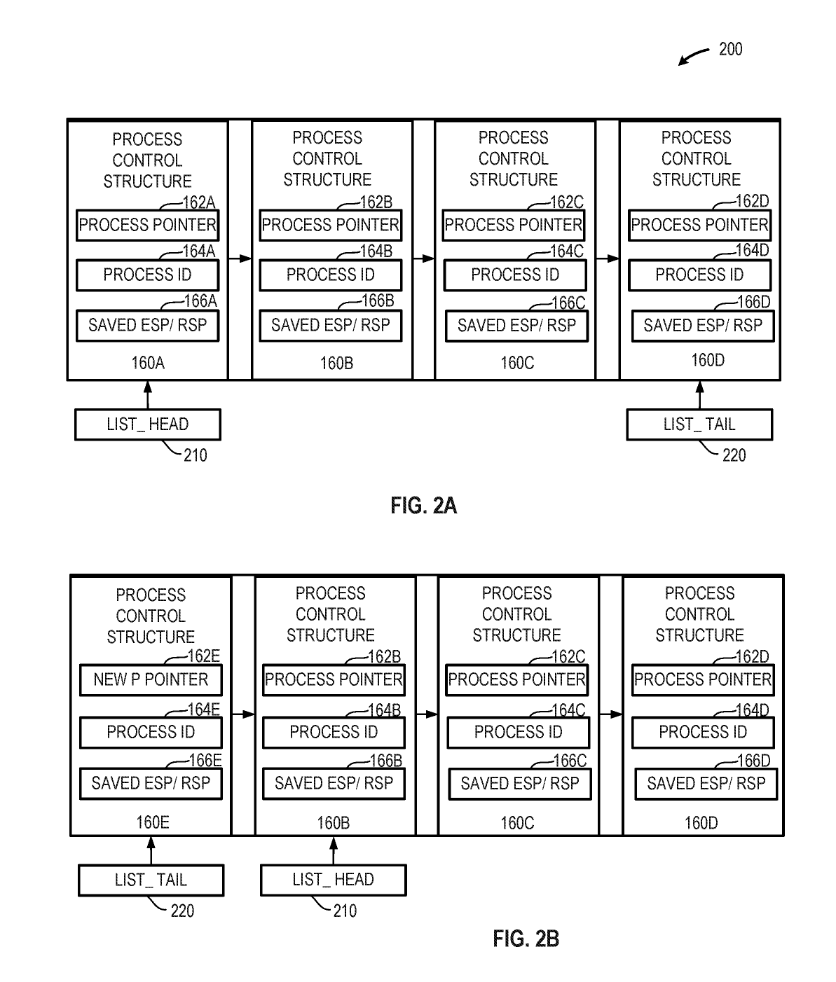

FIG. 2A depicts a data structure 200 that includes four illustrative process control structures 160A-160D, each configured to detect stack-pivot attacks in a respective one of four applications 140A-140D, the data structure includes two pointers, a first pointer (“list_head”) 210 and a second pointer (“list_tail”) 220 in accordance with at least one embodiment described herein. FIG. 2B depicts a data structure 200 that includes four illustrative process control structures 160B-160D and a new process control structure 160E logically associated with an application 140E not previously represented in data structure 200, in accordance with at least one embodiment described herein. The data structure 200 may include any number (“N”) of process control structures 160-160n. As depicted in FIG. 2A, the data structure 200 includes four process control structures 160A-160D. In embodiments, the greater the number of process control structures 160 included in data structure 200, the greater the latency of the system. Thus the value of “N” (i.e., the number of processes or applications 140 monitored at a given time) may be determined, based at least in part, on the desired, permissible, or allowable latency of system 200. The first pointer 210 and the second pointer 220 move in a circular list to implement a least recently used (LRU) replacement.

In operation, the stack-pivot detection circuitry 112 checks if the currently scheduled application is included in the data structure 200. In embodiments, the stack-pivot detection circuitry 112 may check if a process control structure 160 associated with the application 140 is included in the data structure 200. In embodiments, the stack-pivot detection circuitry 112 may confirm the identity of the application 140 using the process pointer 162 is included in the data structure 200 and confirms the identity of the application using the process ID 164.

If the stack-pivot detection circuitry 112 confirms the application 140 appears in the data structure 200, the stack-pivot detection circuitry 112 checks whether the ESP/RSP value in the process control structure 160 has changed by an amount greater than the allowable processor stack offset change value. If the processor stack offset value determined using the saved ESP/RSP 166 exceeds the allowable processor stack offset change value, a stack-pivot has been detected and the application 140 is marked for termination since the application 140 has been exploited and is unrecoverable. If the processor stack offset value determined using the saved ESP/RSP 166 is less than or equal to the allowable processor stack offset change value, a stack-pivot has not occurred, the saved ESP/RSP 166 is updated with the current ESP/RSP value and the application 140 is permitted to continue execution.

Referring now to FIG. 2B, if the stack-pivot detection circuitry 112 fails to detect the application in the data structure 200, the stack-pivot detection circuitry 112 adds the application 140 at the location designated by the first pointer 210 (i.e., the first position in the data structure 200), transitions the second pointer 220 to the first pointer 210 (i.e., transitions the second pointer 220 to the first position in the data structure 200) and points the first pointer 210 to the next process control structure 160 in the data structure 200 (i.e., the second position in the data structure 200).

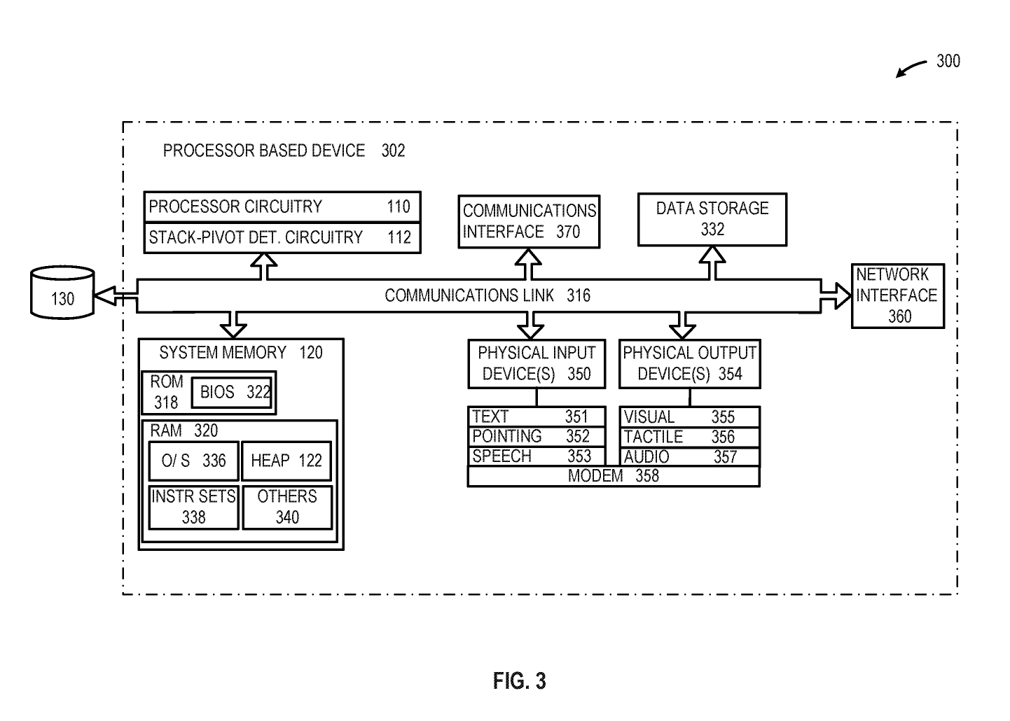

FIG. 3 and the following discussion provide a brief, general description of the components forming an illustrative processor-based device 302 capable of implementing stack-pivot detection circuitry 112 to detect stack-pivot attacks, in accordance with at least one embodiment described herein. The processor-based device 302 includes processor circuitry 110 capable of implementing, forming, or otherwise providing stack-pivot detection circuitry 112 in which the various illustrated embodiments described herein can be implemented. Although not required, some portion of the embodiments will be described in the general context of machine-readable or computer-executable instruction sets, such as program application modules, objects, or macros being executed by the stack-pivot detection circuitry 112. Those skilled in the relevant art will appreciate that the illustrated embodiments as well as other embodiments can be practiced with other circuit-based device configurations, including portable electronic or handheld electronic devices, for instance smartphones, portable computers, wearable computers, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The processor circuitry 110 and/or the stack-pivot detection circuitry 112 may include any number of circuits, some or all of which may include programmable and/or configurable combinations of electronic components, semiconductor devices, and/or logic elements that are disposed partially or wholly in a PC, server, or other computing system capable of executing machine-readable instructions. The processor-based device 302 may include processor circuitry 110, and may, at times, include a bus or similar communications link 316 that communicably couples and facilitates the exchange of information and/or data between various system components including a system memory 120 and the processor circuitry 110. The processor-based device 302 may be referred to in the singular herein, but this is not intended to limit the embodiments to a single device and/or system, since in certain embodiments, there will be more than one processor-based device 302 that incorporates, includes, or contains any number of communicably coupled, collocated, or remote networked circuits or devices.

The processor circuitry 110 may include any number, type, or combination of devices. At times, the processor circuitry 110 may be implemented in whole or in part in the form of semiconductor devices such as diodes, transistors, inductors, capacitors, and resistors. Such an implementation may include, but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), field programmable gate arrays (FPGAs), and the like. Unless described otherwise, the construction and operation of the various blocks shown in FIG. 3 are of conventional design. As a result, such blocks need not be described in further detail herein, as they will be understood by those skilled in the relevant art. The communications link 316 that interconnects at least some of the components of the processor-based device 302 may employ any known serial or parallel bus structures or architectures.

The system memory 120 may include read-only memory (“ROM”) 318 and random access memory (“RAM”) 320. A portion of the ROM 318 may be used to store or otherwise retain a basic input/output system (“BIOS”) 322. The BIOS 322 provides basic functionality to the processor-based device 302, for example by causing the processor circuitry 110 to load one or more machine-readable instruction sets. In embodiments, at least some of the one or more machine-readable instruction sets cause at least a portion of the processor circuitry 110 to provide, create, produce, transition, and/or function as a dedicated, specific, and particular machine, such as stack-pivot detection circuitry 112, system scheduler circuitry 114, and/or system performance management circuitry 116.

The processor-based device 302 may include one or more communicably coupled, non-transitory, data storage devices 130. The one or more data storage devices 130 may be disposed local to and/or remote from the processor-based device 302. The one or more data storage devices 130 may include any current or future developed storage appliances, networks, and/or devices. Non-limiting examples of such data storage devices 130 may include, but are not limited to, any current or future developed non-transitory storage appliances or devices, such as one or more magnetic storage devices, one or more optical storage devices, one or more solid-state electromagnetic storage devices, one or more electro-resistive storage devices, one or more molecular storage devices, one or more quantum storage devices, or various combinations thereof. In some implementations, the one or more data storage devices 130 may include one or more removable storage devices, such as one or more flash drives, flash memories, flash storage units, or similar appliances or devices capable of communicable coupling to and decoupling from the processor-based device 302.

The one or more storage devices 130 may include interfaces or controllers (not shown) communicatively coupling the respective storage device or system to the communications link 316. The one or more storage devices 130 may contain machine-readable instruction sets, data structures, program modules, data stores, databases, logical structures, and/or other data useful to the processor circuitry 110 and/or the stack-pivot detection circuitry 112. In some instances, one or more external storage devices 130 may be communicably coupled to the processor circuitry 110, for example via communications link 310 or via one or more wired communications interfaces (e.g., Universal Serial Bus or USB); one or more wireless communications interfaces (e.g., Bluetooth®, Near Field Communication or NFC); one or more wired network interfaces (e.g., IEEE 802.3 or Ethernet); and/or one or more wireless network interfaces (e.g., IEEE 802.11 or WiFi®).

Machine-readable instruction sets 338 and other modules 340 may be stored in whole or in part in the system memory 120. Such instruction sets 338 may be transferred, in whole or in part, from one or more internal data storage devices 332 and/or one or more external storage devices 130. The instruction sets 338 may be loaded, stored, or otherwise retained in system memory 120, in whole or in part, during execution by the processor circuitry 110. The machine-readable instruction sets 338 may include machine-readable and/or processor-readable code, instructions, or similar logic capable of providing the stack-pivot detection functions and capabilities described herein.

For example, the one or more machine-readable instruction sets 338 may cause the stack-pivot detection circuitry 112 to determine a respective allowable processor stack offset change value for each of a number of applications 140 executed by the processor circuitry 110. In addition, the one or more machine-readable instruction sets 338 may cause the stack-pivot detection circuitry 112 to detect an occurrence of a processor stack exchange instruction and/or a processor stack update instruction in the processor stack 150 associated with an application 140 executed by the processor circuitry 110. In addition, the one or more machine-readable instruction sets 338 may cause the stack-pivot detection circuitry 112 to determine a respective processor stack offset change value for each of the number of applications 140 executed by the processor circuitry 110. Additionally, the one or more machine-readable instruction sets 338 may cause the stack-pivot detection circuitry 112 to, for each of the number of applications 140 executed by the processor circuitry 110, compare the respective determined processor stack offset change value with the allowable processor stack offset change value associated with the respective application 140. Further, the one or more machine-readable instruction sets 338 may cause the stack-pivot detection circuitry 112 to selectively terminate the execution of an application 140 responsive to identifying a stack-pivot attack in which the determined processor stack offset change value associated with the respective application 140 exceeds the allowable processor stack offset change value associated with the respective application 140. Further, the one or more machine-readable instruction sets 338 may cause the stack-pivot detection circuitry 112 to selectively continue the execution of an application 140 responsive to identifying a stack-pivot attack in which the determined processor stack offset change value associated with the respective application 140 is less than or equal to the allowable processor stack offset change value associated with the respective application 140.

Processor-based device users may provide, enter, or otherwise supply commands (e.g., acknowledgements, selections, confirmations, and similar) as well as information and/or data (e.g., subject identification information, color parameters) to the processor-based device 302 using one or more communicably coupled input devices 350 such as one or more text entry devices 351 (e.g., keyboard), one or more pointing devices 352 (e.g., mouse, trackball, touchscreen), and/or one or more audio input devices 353. Some or all of the physical input devices 350 may include a wired or a wireless communicable coupling to the processor-based device 302.

Processor-based device users may receive output from the processor-based device 302 via one or more output devices 354. In at least some implementations, the one or more output devices 354 may include, but are not limited to, one or more: video output or display devices 355; tactile output devices 356; audio output devices 357, or combinations thereof. Some or all of the input devices 350 and some or all of the output devices 354 may be communicably coupled to the processor-based device 302 via one or more wired or wireless interfaces.

For convenience, a network interface 360, the processor circuitry 110, the system memory 120, the input devices 350 and the output devices 354 are illustrated as communicatively coupled to each other via the communications link 316, thereby providing connectivity between the above-described components. In alternative embodiments, the above-described components may be communicatively coupled in a different manner than illustrated in FIG. 3. For example, one or more of the above-described components may be directly coupled to other components, or may be coupled to each other, via one or more intermediary components (not shown). In some embodiments, all or a portion of the communications link 516 may be omitted and the components are coupled directly to each other using suitable wired or wireless connections.

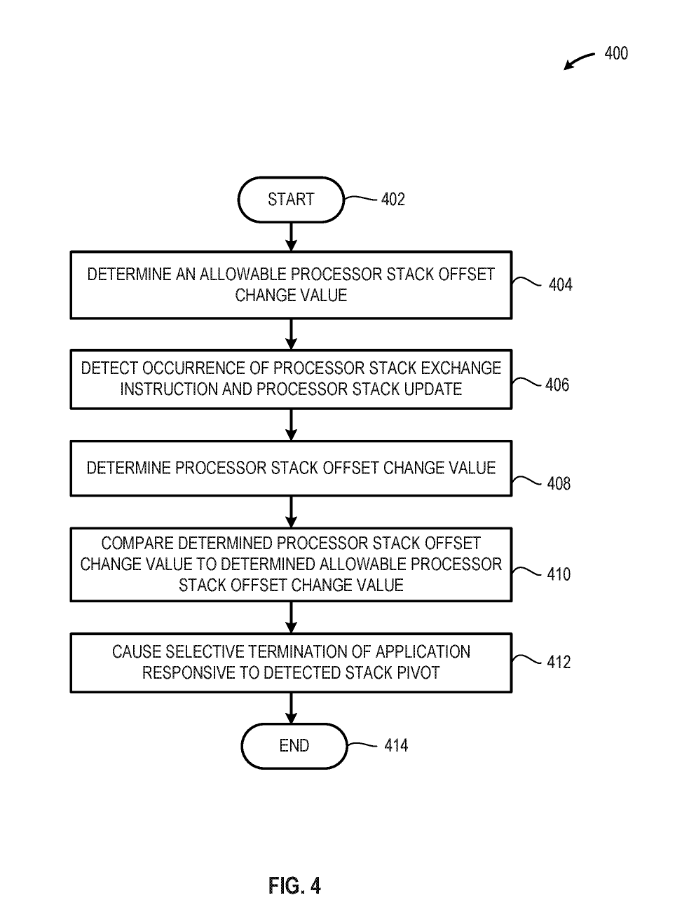

FIG. 4 depicts a high-level logic flow diagram of an illustrative stack-pivot detection method 400, in accordance with at least one embodiment described herein. Return oriented programming (ROP) represents a class of attacks used by an attacker may use to cause unintended and potentially malicious operation and/or use of a processor-based device 302.

Using ROP, an attacker causes an out-of-order execution of currently existing code to cause unexpected or arbitrary computations. ROP attacks often group together gadgets to perform the final malicious action intended by the attacker. To jump between the gadgets (and cause the gadgets to execute in the desired order), the attacker uses return addresses on the processor stack. Since each gadget ends in a return (ret) instruction, the execution of the next gadget occurs immediately. In many instances the attacker pivots the processor stack to a memory area (usually in the heap 122) that is controlled the attacker. The method 400 to detect such stack-pivot attacks commences at 402.

At 404, the stack-pivot detection circuitry 112 determines a respective allowable processor stack offset change value for each of a number of applications 140 executed by processor circuitry 110. In some implementations, the allowable stack offset change value for some or all of the applications 140 may be based on the maximum subroutine length in the respective application 140. In some implementations, the allowable processor stack offset change value for some or all of the applications 140 may be based on the maximum stack size for the system 100.

At 406, the stack-pivot detection circuitry 112 detects an occurrence of a processor stack exchange (xchg) instruction 152 and a processor stack update in at least one application 140 executed by the processor circuitry 110.

At 408, the stack-pivot detection circuitry 112 determines a processor stack offset change value for the at least one application 140 responsive to detecting the occurrence of at least one of: the processor stack exchange (xchg) instruction 152; and the processor stack update in respective application 140. In some implementations, the processor stack offset change value may approximate the change in addresses during the execution of instructions associated with normal execution of the respective application 140. In such instances, the processor stack offset change value is less than or equal to the allowable stack offset change value. In some implementations, the processor stack offset change value may approximate the change in addresses during the execution of instructions associated with malicious execution of a number of gadgets as a result of a stack-pivot attack. In such instances, the processor stack offset change value is greater the allowable stack offset change value.

At 410, the stack-pivot detection circuitry 112 compares the allowable stack offset change value determined at 404 with the processor stack offset change value determined at 408.

At 412, responsive to detecting a stack-pivot attack based on the processor stack offset change value exceeding the allowable stack offset change value, the stack-pivot detection circuitry 112 causes the selective termination of the respective application 140. The method 400 concludes at 414.

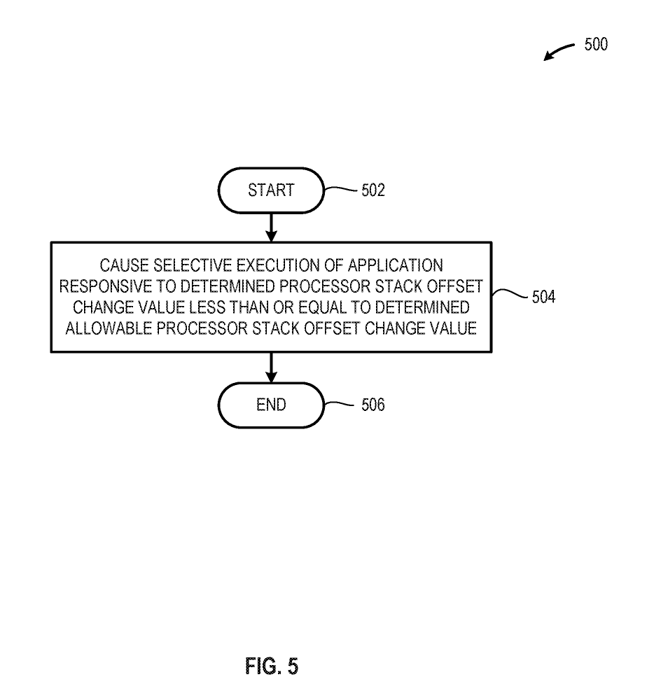

FIG. 5 depicts a high-level logic flow diagram of an illustrative stack-pivot detection method 500, in accordance with at least one embodiment described herein. The method 500 may be used in conjunction with the method 400 depicted in FIG. 4. The method 500 to detect such stack-pivot attacks commences at 502.

At 504, responsive to detecting the processor stack offset change value is less than or equal to the allowable stack offset change value, the stack-pivot detection circuitry 112 causes the selective execution of the respective application 140. The method 500 concludes at 506.

While FIGS. 4 and 5 illustrate various operations according to one or more embodiments, it is to be understood that not all of the operations depicted in FIGS. 4 and 5 are necessary for other embodiments. Indeed, it is fully contemplated herein that in other embodiments of the present disclosure, the operations depicted in FIGS. 4 and 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

The present disclosure is directed to systems and methods for detecting stack pivot attacks. The systems and methods described herein determine an allowable processor stack offset change value for an application executed by the processor circuitry. The systems and methods described herein further detect an occurrence of a processor stack exchange instruction and a processor stack update in the application executed by the processor circuitry and determine a processor stack offset change value for the application responsive to detection of the processor stack exchange instruction and the resultant processor stack update. The systems and methods described herein then compare the determined processor stack offset change value to the determined allowable processor stack offset change value for the application. If the detected stack-pivot indicated by the determined processor stack offset change value exceeds the previously determined allowable processor stack offset change value, the systems and methods described herein further cause a selective termination of the application to terminate the potential stack pivot attack.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for detecting stack pivot attacks by comparing an actual stack offset change value with a defined maximum allowable stack offset change value.

According to example 1, there is provided a system to detect processor stack-pivot attacks. The system, may include: processor circuitry; a memory communicably coupled to the processor circuitry; and a storage device that includes instructions that, when executed by the processor circuitry causes the processor circuitry to: determine an allowable processor stack offset change value for an application executed by the processor circuitry; detect an occurrence of a processor stack exchange instruction and a processor stack update in the application executed by the processor circuitry; determine a processor stack offset change value for the application responsive to detection of the processor stack exchange instruction and the resultant processor stack update; compare the determined processor stack offset change value to the determined allowable processor stack offset change value for the application; and cause a selective termination of the application responsive to a detected stack-pivot indicated by the determined processor stack offset change value exceeding the determined allowable processor stack offset change value.

Example 2 may include elements of example 1 where the instructions, when executed by the processor circuitry, may further cause the processor circuitry to cause a selective execution of the application responsive to a determination that the processor stack offset change value is less than or equal to the defined allowable processor stack offset change value.

Example 3 may include elements of example 1 where the instructions that cause the processor circuitry to determine an allowable processor stack offset change value for an application executed by the processor circuitry may further cause the processor circuitry to: determine a respective allowable processor stack offset change value for each application included in a plurality of applications executed by the processor circuitry.

Example 4 may include elements of example 3 where the instructions that cause the processor circuitry to detect an occurrence of a processor stack exchange instruction and a processor stack update in the application executed by the processor circuitry may further cause the processor circuitry to detect an occurrence of a processor stack exchange instruction and a processor stack update in one or more applications included in the plurality of applications executed by the processor circuitry.

Example 5 may include elements of example 4 where the instructions that cause the processor circuitry to determine a processor stack offset change value for the application responsive to detection of the processor stack exchange instruction and the resultant processor stack update may further cause the processor circuitry to determine a respective processor stack offset change value for each of the one or more applications responsive to detection of the respective processor stack exchange instruction and the processor stack update in the application. Example 6 may include elements of example 5 where the instructions that cause the processor circuitry to compare the determined processor stack offset change value to the determined allowable processor stack offset change value may further cause the processor circuitry to compare each of the respective determined processor stack offset change value for each of the one or more applications to the determined allowable processor stack offset change value associated with the respective application.

Example 7 may include elements of example 6 where the instructions that cause the processor circuitry to cause a selective termination of the application responsive to a detected stack-pivot indicated by the determined processor stack offset change value exceeding the determined allowable processor stack offset change value may further cause the processor circuitry to cause selective termination of each of the one or more applications responsive to a detected stack-pivot in the application indicated by the respective determined processor stack offset change value for the application exceeding the respective determined allowable processor stack offset change value for the application.

Example 8 may include elements of example 7 where the instructions may further cause the processor circuitry to cause selective execution of the one or more applications responsive to a determination that the respective processor stack offset change value for the application is less than or equal to the respective defined allowable processor stack offset change value for the application.

According to example 9, there is provided a method to detect processor stack pivoting attacks. The method may include: determining, by processor circuitry, an allowable processor stack offset change value for an application executed by the processor circuitry; detecting, by the processor circuitry, an occurrence of a processor stack exchange instruction and a processor stack update in the application executed by the processor circuitry; determining, by the processor circuitry, a processor stack offset change value for the application responsive to detection of the processor stack exchange instruction and the processor stack update; comparing, by the processor circuitry, the determined processor stack offset change value to the determined allowable processor stack offset change value; and causing, by the processor circuitry, selective termination of the application responsive to a detected stack-pivot indicated by the determined processor stack offset change value exceeding the determined allowable processor stack offset change value.

Example 10 may include elements of example 9, and the method may additionally include causing, by the processor circuitry, selective execution of the respective application responsive to the determined processor stack offset change value being less than or equal to the determined allowable processor stack offset change value.

Example 11 may include elements of example 9 where determining an allowable processor stack offset change value for an application executed by the processor circuitry may further include determining, by the processor circuitry, an allowable processor stack offset change value for each application included in a plurality of applications executed by the processor circuitry.

Example 12 may include elements of example 11 where detecting an occurrence of a processor stack exchange instruction and a processor stack update in the application executed by the processor circuitry may further include detecting, by the processor circuitry, an occurrence of a processor stack exchange instruction and a processor stack update in one or more applications included in the plurality of application executed by the processor circuitry.

Example 13 may include elements of example 12 where determining a processor stack offset change value during execution of at least one application responsive to detecting the processor stack exchange instruction and the resultant processor stack update may further include determining, by the processor circuitry, a respective processor stack offset change value for each of the one or more applications responsive to detection of the respective processor stack exchange instruction and the processor stack update in the application.

Example 14 may include elements of example 13 where comparing the determined processor stack offset change value to the determined allowable processor stack offset change value may further include comparing, by the processor circuitry, each respective determined processor stack offset change value for each of the one or more applications to a respective determined allowable processor stack offset change value for the respective application.

Example 15 may include elements of example 13 where causing selective termination of the application responsive to a detected stack-pivot indicated by the determined processor stack offset change value exceeding the determined allowable processor stack offset change value may further include causing, by the processor circuitry, selective termination of each of the one or more applications responsive to a detected stack-pivot indicated by the respective determined processor stack offset change value for the application exceeding the respective determined allowable processor stack offset change value for the application.

Example 16 may include elements of example 15, and the method may additionally include causing, by the processor circuitry, execution of the one or more applications responsive to a determination that the respective processor stack offset change value for the application is less than or equal to the respective defined allowable processor stack offset change value for the application.

According to example 17, there is provided a system to detect processor stack pivoting attacks. The system may include a means for determining an allowable processor stack offset change value for an application executed by the processor circuitry; a means for detecting, by the processor circuitry, an occurrence of a processor stack exchange instruction and a processor stack update in the application executed by the processor circuitry; a means for determining a processor stack offset change value for the application responsive to detection of the processor stack exchange instruction and the processor stack update; a means for comparing the determined processor stack offset change value to the determined allowable processor stack offset change value; and a means for causing selective termination of the application responsive to a detected stack-pivot indicated by the determined processor stack offset change value exceeding the determined allowable processor stack offset change value.

Example 18 may include elements of example 17 and the system may further include a means for causing selective execution of the respective application responsive to the determined processor stack offset change value being less than or equal to the determined allowable processor stack offset change value.

Example 19 may include elements of example 17 where the means for determining an allowable processor stack offset change value for an application executed by the processor circuitry may further include a means for determining an allowable processor stack offset change value for each application included in a plurality of applications executed by the processor circuitry.

Example 20 may include elements of example 19 where the means for detecting an occurrence of a processor stack exchange instruction and a processor stack update in the application executed by the processor circuitry may further include a means for detecting an occurrence of a processor stack exchange instruction and a processor stack update in one or more applications included in the plurality of application executed by the processor circuitry.

Example 21 may include elements of example 20 where the means for determining a processor stack offset change value during execution of at least one application responsive to detecting the processor stack exchange instruction and the resultant processor stack update may further include a means for determining a respective processor stack offset change value for each of the one or more applications responsive to detection of the respective processor stack exchange instruction and the processor stack update in the application.

Example 22 may include elements of example 21 where the means for comparing the determined processor stack offset change value to the determined allowable processor stack offset change value may further include a means for comparing each respective determined processor stack offset change value for each of the one or more applications to a respective determined allowable processor stack offset change value for the respective application.

Example 23 may include elements of example 22 where the means for causing selective termination of the application responsive to a detected stack-pivot indicated by the determined processor stack offset change value exceeding the determined allowable processor stack offset change value may further include a means for causing selective termination of each of the one or more applications responsive to a detected stack-pivot indicated by the respective determined processor stack offset change value for the application exceeding the respective determined allowable processor stack offset change value for the application.

Example 24 may include elements of example 23 and the system may further include a means for causing execution of the one or more applications responsive to a determination that the respective processor stack offset change value for the application is less than or equal to the respective defined allowable processor stack offset change value for the application.

According to example 25, there is provided a stack-pivot detection apparatus. The stack-detection apparatus may include stack-pivot detection circuitry to: determine an allowable processor stack offset change value for an application executed by processor circuitry; detect an occurrence of a processor stack exchange instruction and a processor stack update in the application executed by the processor circuitry; determine a processor stack offset change value for the application responsive to detection of the processor stack exchange instruction and the resultant processor stack update; compare the determined processor stack offset change value to the determined allowable processor stack offset change value for the application; and cause a selective termination of the application responsive to a detected stack-pivot indicated by the determined processor stack offset change value exceeding the determined allowable processor stack offset change value.

Example 26 may include elements of example 25, and the apparatus may further cause selective execution of the respective application responsive to the determined processor stack offset change value being less than or equal to the determined allowable processor stack offset change value.

Example 27 may include elements of example 25 where to determine an allowable processor stack offset change value for an application executed by processor circuitry, the stack-pivot detection apparatus may further determine an allowable processor stack offset change value for each application included in a plurality of applications executed by the processor circuitry.

Example 28 may include elements of example 27 where to detect an occurrence of a processor stack exchange instruction and a processor stack update in the application executed by the processor circuitry, the stack-pivot detection apparatus may further: detect an occurrence of a processor stack exchange instruction and a processor stack update in one or more applications included in the plurality of application executed by the processor circuitry.

Example 29 may include elements of example 28 where to determine a processor stack offset change value during execution of at least one application responsive to detecting the processor stack exchange instruction and the resultant processor stack update, the stack-pivot detection apparatus may further determine a respective processor stack offset change value for each of the one or more applications responsive to detection of the respective processor stack exchange instruction and the processor stack update in the application.

Example 30 may include elements of example 29 where to compare the determined processor stack offset change value to the determined allowable processor stack offset change value, the stack-pivot detection apparatus may further: compare each respective determined processor stack offset change value for each of the one or more applications to a respective determined allowable processor stack offset change value for the respective application.

Example 31 may include elements of example 30 where to cause selective termination of the application responsive to a detected stack-pivot indicated by the determined processor stack offset change value exceeding the determined allowable processor stack offset change value, the stack-pivot detection apparatus may further: cause selective termination of each of the one or more applications responsive to a detected stack-pivot indicated by the respective determined processor stack offset change value for the application exceeding the respective determined allowable processor stack offset change value for the application.

Example 32 may include elements of example 31, and the apparatus may further cause execution of the one or more applications responsive to a determination that the respective processor stack offset change value for the application is less than or equal to the respective defined allowable processor stack offset change value for the application.

According to example 33, there is provided a non-transitory computer readable medium that includes instructions. The instructions, when executed by processor circuitry, may cause the processor circuitry to: determine an allowable processor stack offset change value for an application executed by the processor circuitry; detect an occurrence of a processor stack exchange instruction and a processor stack update in the application executed by the processor circuitry; determine a processor stack offset change value for the application responsive to detection of the processor stack exchange instruction and the resultant processor stack update; compare the determined processor stack offset change value to the determined allowable processor stack offset change value for the application; and cause a selective termination of the application responsive to a detected stack-pivot indicated by the determined processor stack offset change value exceeding the determined allowable processor stack offset change value.

Example 34 may include elements of example 33 where the instructions may further cause the processor circuitry to: cause a selective execution of the application responsive to a determination that the processor stack offset change value is less than or equal to the defined allowable processor stack offset change value.

Example 35 may include elements of example 33 where the instructions that cause the processor circuitry to determine an allowable processor stack offset change value for an application executed by the processor circuitry may further cause the processor circuitry to: determine a respective allowable processor stack offset change value for each application included in a plurality of applications executed by the processor circuitry.

Example 36 may include elements of example 35 where the instructions that cause the processor circuitry to detect an occurrence of a processor stack exchange instruction and a processor stack update in the application executed by the processor circuitry may further cause the processor circuitry to: detect an occurrence of a processor stack exchange instruction and a processor stack update in one or more applications included in the plurality of applications executed by the processor circuitry.

Example 37 may include elements of example 36 where the instructions that cause the processor circuitry to determine a processor stack offset change value for the application responsive to detection of the processor stack exchange instruction and the resultant processor stack update may further cause the processor circuitry to: determine a respective processor stack offset change value for each of the one or more applications responsive to detection of the respective processor stack exchange instruction and the processor stack update in the application.

Example 38 may include elements of example 37 where the instructions that cause the processor circuitry to compare the determined processor stack offset change value to the determined allowable processor stack offset change value may further cause the processor circuitry to: compare each of the respective determined processor stack offset change value for each of the one or more applications to the determined allowable processor stack offset change value associated with the respective application.

Example 39 may include elements of example 38 where the instructions that cause the processor circuitry to cause a selective termination of the application responsive to a detected stack-pivot indicated by the determined processor stack offset change value exceeding the determined allowable processor stack offset change value may further cause the processor circuitry to: cause selective termination of each of the one or more applications responsive to a detected stack-pivot in the application indicated by the respective determined processor stack offset change value for the application exceeding the respective determined allowable processor stack offset change value for the application.

Example 40 may include elements of example 39 where the instructions may further cause the processor circuitry to: cause selective execution of the one or more applications responsive to a determination that the respective processor stack offset change value for the application is less than or equal to the respective defined allowable processor stack offset change value for the application.

According to example 41, there is provided a system for detecting stack-pivot attacks, the system being arranged to perform the method of any of examples 9 through 16.

According to example 42, there is provided a chipset arranged to perform the method of any of examples 9 through 16.

According to example 43, there is provided a non-transitory machine readable medium comprising a plurality of instructions that, in response to be being executed on a computing device, cause the computing device to carry out the method according to any of examples 9 through 16.

According to example 44, there is provided a device configured for detecting stack-pivot attacks, the device being arranged to perform the method of any of examples 9 through 16.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A system to detect processor stack-pivot attacks, the system comprising:
processor circuitry;
a memory communicably coupled to the processor circuitry; and
a storage device that includes instructions that, when executed by the processor circuitry causes the processor circuitry to:
determine an allowable processor stack offset change value for an application executed by the processor circuitry;
detect an occurrence of a processor stack exchange instruction and a processor stack update in the application executed by the processor circuitry;
determine a processor stack offset change value for the application responsive to detection of the processor stack exchange instruction and the resultant processor stack update;
compare the determined processor stack offset change value to the determined allowable processor stack offset change value for the application; and
cause a selective termination of the application responsive to a detected stack-pivot indicated by the determined processor stack offset change value exceeding the determined allowable processor stack offset change value.

2. The system of claim 1 wherein the instructions, when executed by the processor circuitry, further cause the processor circuitry to:
cause a selective execution of the application responsive to a determination that the processor stack offset change value is less than or equal to the defined allowable processor stack offset change value.

3. The system of claim 1 wherein the instructions that cause the processor circuitry to determine an allowable processor stack offset change value for an application executed by the processor circuitry further cause the processor circuitry to:
determine a respective allowable processor stack offset change value for each application included in a plurality of applications executed by the processor circuitry.

4. The system of claim 3 wherein the instructions that cause the processor circuitry to detect an occurrence of a processor stack exchange instruction and a processor stack update in the application executed by the processor circuitry further cause the processor circuitry to:
detect an occurrence of a processor stack exchange instruction and a processor stack update in one or more applications included in the plurality of applications executed by the processor circuitry.

5. The system of claim 4 wherein the instructions that cause the processor circuitry to determine a processor stack offset change value for the application responsive to detection of the processor stack exchange instruction and the resultant processor stack update further cause the processor circuitry to:
determine a respective processor stack offset change value for each of the one or more applications responsive to detection of the respective processor stack exchange instruction and the processor stack update in the application.

6. The system of claim 5 wherein the instructions that cause the processor circuitry to compare the determined processor stack offset change value to the determined allowable processor stack offset change value further cause the processor circuitry to:
compare each of the respective determined processor stack offset change value for each of the one or more applications to the determined allowable processor stack offset change value associated with the respective application.

7. The system of claim 6 wherein the instructions that cause the processor circuitry to cause a selective termination of the application responsive to a detected stack-pivot indicated by the determined processor stack offset change value exceeding the determined allowable processor stack offset change value further cause the processor circuitry to:
cause selective termination of each of the one or more applications responsive to a detected stack-pivot in the application indicated by the respective determined processor stack offset change value for the application exceeding the respective determined allowable processor stack offset change value for the application.

8. The system of claim 7 wherein the instructions further cause the processor circuitry to:
cause selective execution of the one or more applications responsive to a determination that the respective processor stack offset change value for the application is less than or equal to the respective defined allowable processor stack offset change value for the application.

9. The system of claim 1 wherein the instructions that cause the processor circuitry to detect an occurrence of a processor stack exchange instruction and a processor stack update in the application further cause the processor circuitry to:
selectively provide a watching service called by at least one of: an event handler, an intercepted function binary instrumentation, or the system scheduler, the watching service to detect an occurrence of a processor stack exchange instruction and a processor stack update in the application.

10. A method to detect processor stack pivoting attacks, the method comprising:
determining, by processor circuitry, an allowable processor stack offset change value for an application executed by the processor circuitry;
detecting, by the processor circuitry, an occurrence of a processor stack exchange instruction and a processor stack update in the application executed by the processor circuitry;
determining, by the processor circuitry, a processor stack offset change value for the application responsive to detection of the processor stack exchange instruction and the processor stack update;
comparing, by the processor circuitry, the determined processor stack offset change value to the determined allowable processor stack offset change value; and
causing, by the processor circuitry, selective termination of the application responsive to a detected stack-pivot indicated by the determined processor stack offset change value exceeding the determined allowable processor stack offset change value.

11. The method of claim 10, further comprising:
causing, by the processor circuitry, selective execution of the respective application responsive to the determined processor stack offset change value being less than or equal to the determined allowable processor stack offset change value.

12. The method of claim 10 wherein determining an allowable processor stack offset change value for an application executed by the processor circuitry further comprises:
determining, by the processor circuitry, an allowable processor stack offset change value for each application included in a plurality of applications executed by the processor circuitry.

13. The method of claim 12 wherein detecting an occurrence of a processor stack exchange instruction and a processor stack update in the application executed by the processor circuitry further comprises:
detecting, by the processor circuitry, an occurrence of a processor stack exchange instruction and a processor stack update in one or more applications included in the plurality of application executed by the processor circuitry.

14. The method of claim 13 wherein determining a processor stack offset change value during execution of at least one application responsive to detecting the processor stack exchange instruction and the resultant processor stack update further comprises:
determining, by the processor circuitry, a respective processor stack offset change value for each of the one or more applications responsive to detection of the respective processor stack exchange instruction and the processor stack update in the application.

15. The method of claim 14 wherein comparing the determined processor stack offset change value to the determined allowable processor stack offset change value further comprises:
comparing, by the processor circuitry, each respective determined processor stack offset change value for each of the one or more applications to a respective determined allowable processor stack offset change value for the respective application.

16. The method of claim 14 wherein causing selective termination of the application responsive to a detected stack-pivot indicated by the determined processor stack offset change value exceeding the determined allowable processor stack offset change value further comprises:
causing, by the processor circuitry, selective termination of each of the one or more applications responsive to a detected stack-pivot indicated by the respective determined processor stack offset change value for the application exceeding the respective determined allowable processor stack offset change value for the application.

17. The method of claim 16, further comprising:
causing, by the processor circuitry, execution of the one or more applications responsive to a determination that the respective processor stack offset change value for the application is less than or equal to the respective defined allowable processor stack offset change value for the application.

18. A non-transitory computer readable medium that includes instructions that, when executed by processor circuitry causes the processor circuitry to:
determine an allowable processor stack offset change value for an application executed by the processor circuitry;
detect an occurrence of a processor stack exchange instruction and a processor stack update in the application executed by the processor circuitry;
determine a processor stack offset change value for the application responsive to detection of the processor stack exchange instruction and the resultant processor stack update;
compare the determined processor stack offset change value to the determined allowable processor stack offset change value for the application; and
cause a selective termination of the application responsive to a detected stack-pivot indicated by the determined processor stack offset change value exceeding the determined allowable processor stack offset change value.

19. The non-transitory computer readable medium of claim 18 wherein the instructions further cause the processor circuitry to:
cause a selective execution of the application responsive to a determination that the processor stack offset change value is less than or equal to the defined allowable processor stack offset change value.

20. The non-transitory computer readable medium of claim 18 wherein the instructions that cause the processor circuitry to determine an allowable processor stack offset change value for an application executed by the processor circuitry further cause the processor circuitry to:
determine a respective allowable processor stack offset change value for each application included in a plurality of applications executed by the processor circuitry.

21. The non-transitory computer readable medium of claim 20 wherein the instructions that cause the processor circuitry to detect an occurrence of a processor stack exchange instruction and a processor stack update in the application executed by the processor circuitry further cause the processor circuitry to:
detect an occurrence of a processor stack exchange instruction and a processor stack update in one or more applications included in the plurality of applications executed by the processor circuitry.

22. The non-transitory computer readable medium of claim 21 wherein the instructions that cause the processor circuitry to determine a processor stack offset change value for the application responsive to detection of the processor stack exchange instruction and the resultant processor stack update further cause the processor circuitry to:
determine a respective processor stack offset change value for each of the one or more applications responsive to detection of the respective processor stack exchange instruction and the processor stack update in the application.

23. The non-transitory computer readable medium of claim 22 wherein the instructions that cause the processor circuitry to compare the determined processor stack offset change value to the determined allowable processor stack offset change value further cause the processor circuitry to:
compare each of the respective determined processor stack offset change value for each of the one or more applications to the determined allowable processor stack offset change value associated with the respective application.

24. The non-transitory computer readable medium of claim 23 wherein the instructions that cause the processor circuitry to cause a selective termination of the application responsive to a detected stack-pivot indicated by the determined processor stack offset change value exceeding the determined allowable processor stack offset change value further cause the processor circuitry to:
cause selective termination of each of the one or more applications responsive to a detected stack-pivot in the application indicated by the respective determined processor stack offset change value for the application exceeding the respective determined allowable processor stack offset change value for the application.

25. The non-transitory computer readable medium of claim 24 wherein the instructions further cause the processor circuitry to:
cause selective execution of the one or more applications responsive to a determination that the respective processor stack offset change value for the application is less than or equal to the respective defined allowable processor stack offset change value for the application.
